(19) United States
(12) Patent Application Publication
(10) Pub. No.: US 2016/0075104 A1
(43) Pub. Date: Mar. 17, 2016

(54) ANCHORED MULTI-LAYER LINER SYSTEM FOR WASTE WATER SYSTEM REHABILITATION

(71) Applicant: Gulf Coast Underground, LLC, Mobile, AL (US)

(72) Inventor: Chris Gomel, Mobile, AL (US)

(21) Appl. No.: 14/850,324

(22) Filed: Sep. 10, 2015

Related U.S. Application Data
(60) Provisional application No. 62/048,868, filed on Sep. 11, 2014.
(60) Provisional application No. 62/075,475, filed on Nov. 5, 2014.

(51) Int. Cl. B32B 7/08; B32B 5/02; B32B 27/06; B32B 27/38; B32B 27/08

(52) U.S. Cl. CPC B32B 7/08; B32B 27/38; B32B 27/08; B32B 27/065; B32B 5/028; B32B 2266/0278; B32B 2307/726; B32B 2262/101

(57) ABSTRACT

A multi-layer liner system for application to a substrate, comprising a primer layer, a first moisture barrier layer, the first moisture barrier layer being impervious to moisture, a second moisture barrier layer, a foam layer, the foam layer being sandwiched between the first moisture barrier layer and the second moisture barrier layer, and an anchor assembly extending outwardly from the substrate into the multi-layer liner.

### CLAIM OF PRIORITY

This application claims priority to U.S. Provisional Patent Application No. 62/048,868 filed Sep. 11, 2014, and U.S. Provisional Patent Application No. 62/075,475 filed Nov. 5, 2014, the entire disclosures which are incorporated herein.

### FIELD OF THE INVENTION

The present invention relates generally to waste water systems. More particularly, the present invention relates to an anchored multi-layer liner system for use in the rehabilitation or repair of waste water system components such as manholes, sewer pipes, lift stations, etc.

### BACKGROUND OF THE INVENTION

Deterioration of waste water system components is a severe and growing problem. Originally built of brick, block or concrete construction, these components develop leaks, cracks and holes due to age, erosion, corrosion and ground water intrusion. Leakage from old manholes and sewer lines contaminates the environment and sometimes result in catastrophic damage with respect to clean-up and repair costs.

Since the cost of repairing the components is typically much less than the cost of replacement, many techniques have been developed to repair and rehabilitate waste water system components. For example, it is known to recast manholes and the like through the use of forms and poured concrete, such as shown in U.S. Pat. No. 5,032,197 to Trimble. Because this process is very labor intensive, many techniques are directed toward spray-applied liners. For example, U.S. Pat. No. 5,002,438 to Strong teaches the use of sprayed cement to form a liner inside the deteriorating structure. Spray-applied epoxy, acrylic or polyurethane liners are also known, as is the use of resin impregnated substrates, such as felt, as taught in U.S. Pat. No. 5,017,258 to Brown et al.

Note, however, it is not uncommon for current spray-applied systems to suffer from moisture, delamination, shrinkage and structural weakness problems resulting from the typical environment encountered in the repair operation. Moreover, in various instances, it is known for portions of existing liner systems to become separated from the substrate to which they are applied, especially where water intrusion can be expected, accompanied by the subsequent build up of hydrostatic pressure. The joints between pre-cast sections of various waste water components, such as manholes, are known to cause such damage to liners.

The present invention recognizes and addresses considerations of prior art constructions and methods.

### SUMMARY OF THE INVENTION

One embodiment of multi-layer liner system for application to a substrate includes a primer layer, a first moisture barrier layer, the first moisture barrier layer being impervious to moisture, a second moisture barrier layer, a foam layer, the foam layer being sandwiched between the first moisture barrier layer and the second moisture barrier layer, and an anchor assembly extending outwardly from the substrate into the multi-layer liner.

Another embodiment of a multi-layered liner system is a method of applying a multi-layer liner system to a substrate, including the steps of applying a primer layer, applying a first moisture barrier layer to the primer layer, the first moisture barrier layer being impervious to moisture, applying a foam layer to the first moisture barrier layer, applying a second moisture barrier layer to the foam layer so that the foam layer is sandwiched between the first moisture barrier layer and the second moisture barrier layer, and attaching an anchor assembly to the substrate so that the anchor assembly extends outwardly from the substrate into the multi-layer liner.

Yet another embodiment of a multi-layered liner system for application to a substrate includes a foam layer, the foam layer being applied to the substrate, a first moisture barrier layer, the first moisture barrier layer being impervious to moisture and disposed on an outer surface of the foam layer, and an anchor assembly including a first portion disposed within the substrate and a second portion extending outwardly from the substrate into the foam layer so that the second portion is embedded in the foam layer.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1A is a perspective cross-sectional view of a portion of an embodiment of an anchored multi-layer liner system, applied to a waste water system component, in accordance with the present invention;

FIG. 1B is a perspective cross-sectional view of a portion of an alternate embodiment of an anchored multi-layer liner system, applied to a waste water system component, in accordance with the present invention;

FIG. 1C is a perspective cross-sectional view of a portion of an alternate embodiment of an anchored multi-layer liner system, applied to a waste water system component, in accordance with the present invention;

FIG. 1D is a perspective cross-sectional view of a portion of an alternate embodiment of an anchored multi-layer liner system, applied to a waste water system component, in accordance with the present invention;

FIG. 2A is a perspective cross-sectional view of a portion of an alternate embodiment of an anchored multi-layer liner system, applied to a waste water system component, in accordance with the present invention;

FIG. 2B is a perspective cross-sectional view of a portion of an alternate embodiment of an anchored multi-layer liner system, applied to a waste water system component, in accordance with the present invention;

FIG. 2C is a perspective cross-sectional view of a portion of an alternate embodiment of an anchored multi-layer liner system, applied to a waste water system component, in accordance with the present invention;

FIG. 3A is a perspective cross-sectional view of a portion of an alternate embodiment of an anchored multi-layer liner system, applied to a waste water system component, in accordance with the present invention;

FIG. 3B is a perspective cross-sectional view of a portion of an alternate embodiment of an anchored multi-layer liner system, applied to a waste water system component, in accordance with the present invention;

FIG. 3C is a perspective cross-sectional view of a portion of an alternate embodiment of an anchored multi-layer liner system, applied to a waste water system component, in accordance with the present invention;

FIG. 4 is a perspective cross-sectional view of a portion of an alternate embodiment of an anchored multi-layer liner system, applied to a waste water system component, in accordance with the present invention;

FIG. 5 is a perspective cross-sectional view of a portion of an alternate embodiment of an anchored multi-layer liner system, applied to a waste water system component, in accordance with the present invention;

FIG. 6A is a cross-sectional view of a manhole constructed of pre-cast components; and

FIG. 6B is a cross-sectional view of the manhole as shown in FIG. 6A, further including a partial application of the anchored multi-layer liner system shown in FIG. 4.

Repeat use of reference characters in the present specification and drawings is intended to represent same or analogous features or elements of the invention according to the disclosure.

### DETAILED DESCRIPTION

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

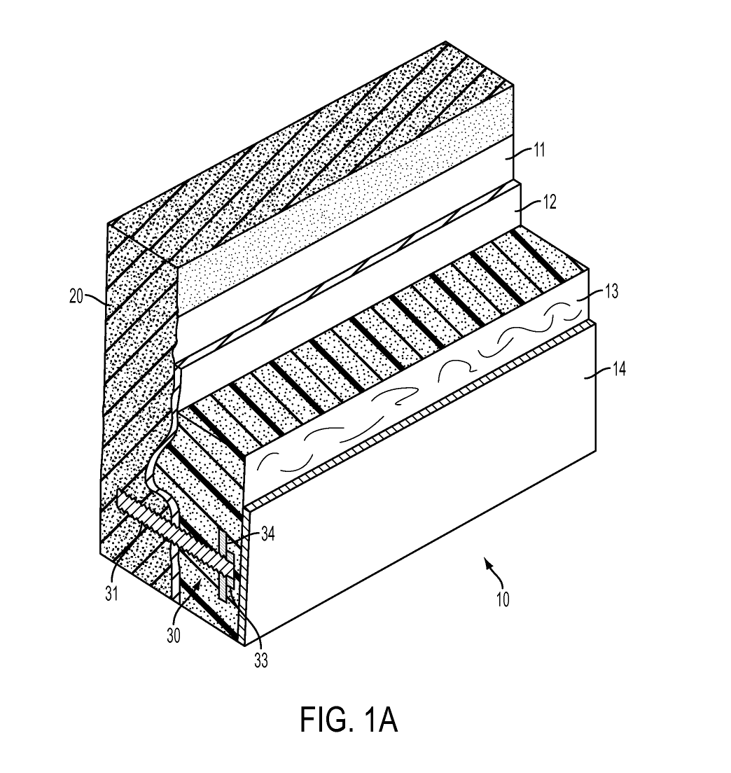

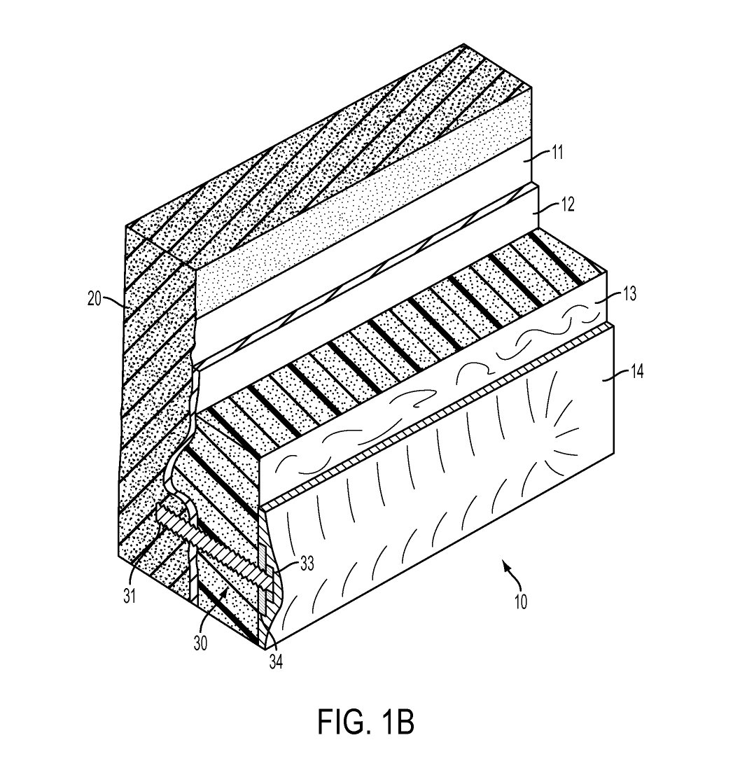

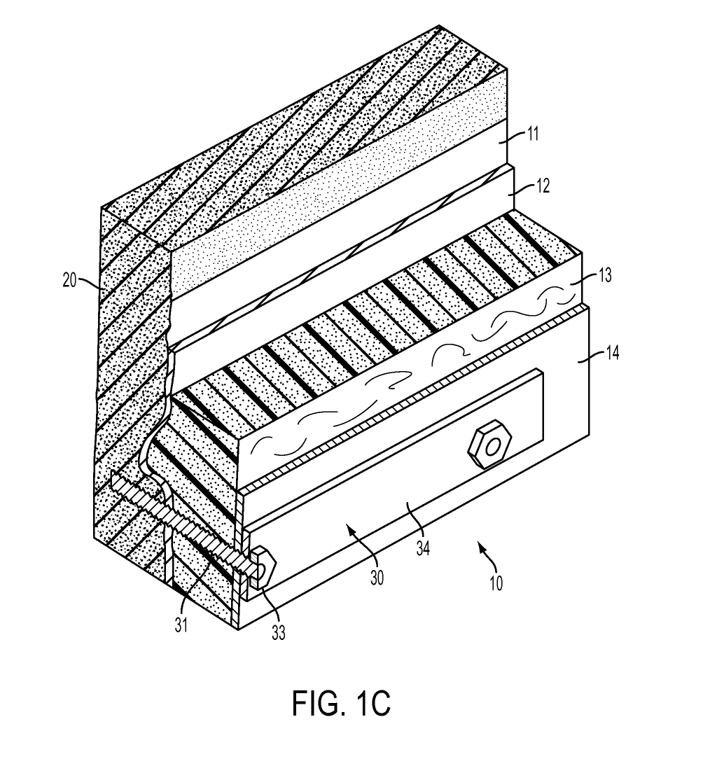

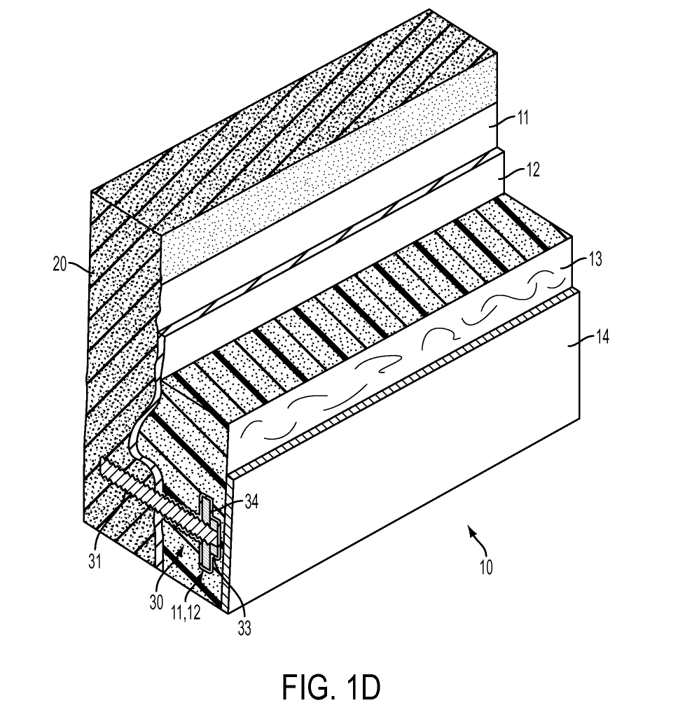

As illustrated by the sectional depiction in FIG. 1A, an embodiment of the present invention comprises a multi-layer liner 10 applied to a concrete, brick, block, metal or the like substrate 20, and further secured thereto by an anchor system 30. Typically, the substrate 20 will be a deteriorated manhole or sewer pipe having an irregular surface with cracks or holes. The liner 10 comprises a primer layer 11, a first moisture barrier layer 12, a foam layer 13, and a second moisture barrier layer 14. Preferably, the liner 10 is applied so as to cover the entire internal surface of the substrate 20, which is usually generally tubular in configuration, although any shape or configuration is possible and the technique is applicable without regard to the particular shape of the substrate 20.

The substrate 20 surface is initially prepared using high pressure water or abrasive sand blasting to remove all hard contaminants, any micro-organisms or living matter such as mold, mildew, etc., and any loose degraded materials of the substrate itself. This abrading step results in a clean surface with an optimized surface for adhesion of the liner 20. Next the primer layer 11 is spray-applied using conventional compressed air spraying devices. The primer layer is a material capable of adhering to the substrate 20 even if wet, and is preferably an epoxy material. The primer layer 11 is applied to a necessary thickness to insure adhesion of the first moisture barrier 12 to the substrate 20, and is generally applied to a dry film thickness between 2 and 10 mils, and preferably at a thickness of approximately 5 mils. The primer layer 12 is coated over the entire surface to be repaired.

The next step is to spray-apply, again using conventional techniques, the first moisture barrier layer 12 onto the primer layer 11. The first moisture barrier layer 12 is preferably composed of a polymer blend of separate components which are mixed as they exit the spray nozzle, the components reacting to form a hard material upon curing. Preferably, a blend of a polyurea component and an isocyanate component is utilized, with the two components formulated to have similar viscosities. The first moisture barrier layer 12 is applied to a dry film thickness of preferably between 40 to 80 mils, and even more preferably at a thickness of 60 mils. The material used for the first moisture barrier should have a gel time of less than a few seconds and preferably less than 3 seconds, with total cure time of less than 60 seconds and preferably less than 30 seconds, and have minimal shrinkage during curing. This rapid cure is necessary to insure integrity of the first moisture barrier 12 even when applied under non-optimum conditions. The preferred polyurea and isocyanate blend has a tensile strength of greater than 1500 psi, an elongation percentage of 125%, tear strength of 350 psi, a shore D hardness of 55 and an 100% modulus of greater than 1500. The first moisture barrier layer 12 is impermeable to water and other fluids and is a structurally rigid layer adhered to the substrate 20 so as to remain adhered under pull test conditions of greater than 300 psi. The first moisture barrier layer 12 is applied to completely cover the primer layer 11.

In the embodiment shown in FIG. 1A, the next step is to install the anchor system 30 to the substrate 20 prior to applying the foam layer 13. In this manner, the portion of the anchor system extending outwardly from the substrate 20 will be fully embedded in the foam layer 13, thereby providing a resistive force to any forces that may tend to cause multi-layer liner 10 to separate from the substrate 20, such as, but not limited to, hydrostatic pressure due to water intrusion. As shown, anchor system 30 includes a plurality of elongated anchor plates 34 (only one is shown) that are each secured to the substrate 20 by one or more fasteners. In the instant case, the fasteners being used comprise a plurality of threaded bolts 31 and correspondingly threaded nuts 33.

After a suitable number of anchor plates 34 have been installed, the next step is to spray-apply, again using conventional techniques, a foam layer 13. The foam layer 13 is preferably composed of a polyurethane blend which rapidly foams and cures upon exiting the spray nozzle of the application equipment. Preferably, the foam material is primarily closed cell and has a rise time of less than 30 seconds and preferably less than 10 seconds. The foam layer 13 is applied preferably to result in a dry thickness of at least 500 mils, although the foam layer 13 can be thicker overall or in selected areas if necessary. The foam layer 13 as applied creates a smoother inner surface, its bulk filling any holes, depressions or cracks in the substrate 20 surface. Additionally, the foam layer 13 encapsulates the exposed anchor plates 34 and associated fasteners, bolts 31 and nuts 33, so that the anchor system 30 provides a plurality of points at which adhesion of the foam layer 13 to the substrate 20 is enhanced. The foam layer 13 preferably has a density of between 4.5 to 5.5 pounds per cubic foot, a compressive strength of between 105 to 110 psi, a closed cell content of over 90 percent, and shear strength of between 225 to 250 psi. As with the other layers, the foam layer 13 is applied over the entire previous layer.

Finally, the second moisture barrier layer 14, preferably composed of the same material as the first moisture barrier layer 12, is spray-applied over the entire surface of foam layer 13. Preferably, the second moisture barrier layer 14 is also applied to a dry film thickness of between 40 and 80 mils, and even more preferably to a thickness of approximately 60 mils. If necessary due to circumstances, greater thicknesses of first moisture barrier layer 12 and second moisture barrier layer 14 may be utilized.

The resulting anchored multi-layer liner 10 is a water impermeable barrier strongly adhered to the substrate 20, via its own adhesive properties as well as the anchor system 30, which prevents liquids from leaking out of the waste water system and also prevents ground water from entering the system. More importantly in terms of longevity, the liner 10 is a structural member which strengthens the components of the waste water system no matter to what extent they have deteriorated. Previously used water impermeable liners, whether composed of epoxy, acrylic, polyurethane or resin impregnated substrates, are not strongly adhered to the substrate and tend to delaminate over time. These typical liners do not reinforce or impart any structural strength to the system components. The multi-layer liner 10 of the invention not only creates a liquid barrier, it adds to the strength of the waste water system components by providing a reinforcing member which is structurally rigid due to its multi-layer composition. The liner 10 is a stressed skin panel, comprised of a structurally rigid foam internal layer 13 bounded by two adhered surface layers, first moisture barrier layer 12 and second moisture barrier layer 14, which are under stress due to the rapid cure rate of the material when applied. This rapid cure time does not allow internal stresses created by the small amount of shrinkage during curing to be relaxed, as occurs in sprayed films with long cure times. The principles of stressed skin panels, well known in the construction industry for walls of large buildings, provide for a structural member with increased structural strength and integrity of multiple factors beyond that of the individual components taken separately. Thus, the combination of the stressed skin panel created by the multi-layer combination of first moisture barrier layer 12, foam internal layer 13 and second moisture barrier layer 14 adhered to the waste water system component results in a repaired component with exceptional structural characteristics due to the reinforcing properties of the liner 10, and is a vastly improved system over those in use today.

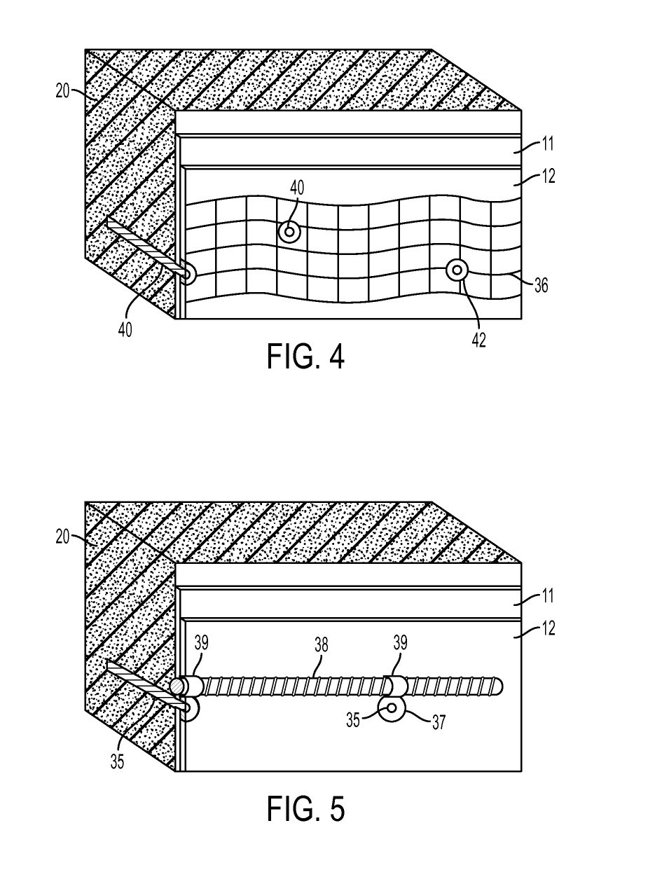

Referring now to FIG. 1B, an alternate embodiment of the anchored multi-layer liner 10 includes, similarly to the first embodiment, a plurality of anchor plates 34 that are secured to substrate 20 by way of bolts 31 and nuts 33. Additionally, other fasteners may be used such as powder activated fasteners 40, 42 (FIG. 4). Note, however, that this embodiment differs from the first embodiment shown in FIG. 1A in that each anchor plate 34 is disposed between foam layer 13 and second moisture barrier layer 14 rather than in the foam layer 13. As shown in FIG. 1C, anchor plate 34 is disposed on top of second moisture barrier layer 14. As shown in FIG. 1D. anchor plate 34 is encapsulated by first moisture barrier layer 12.

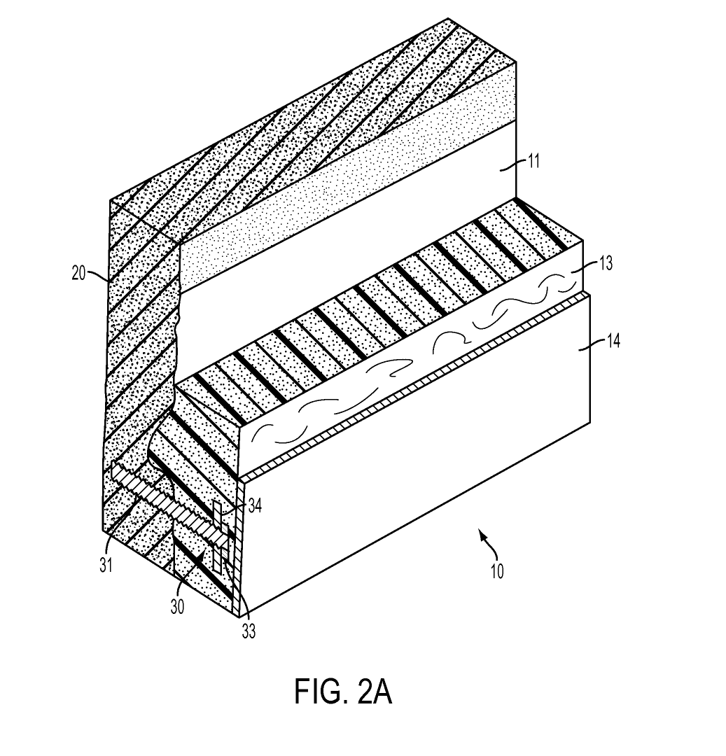

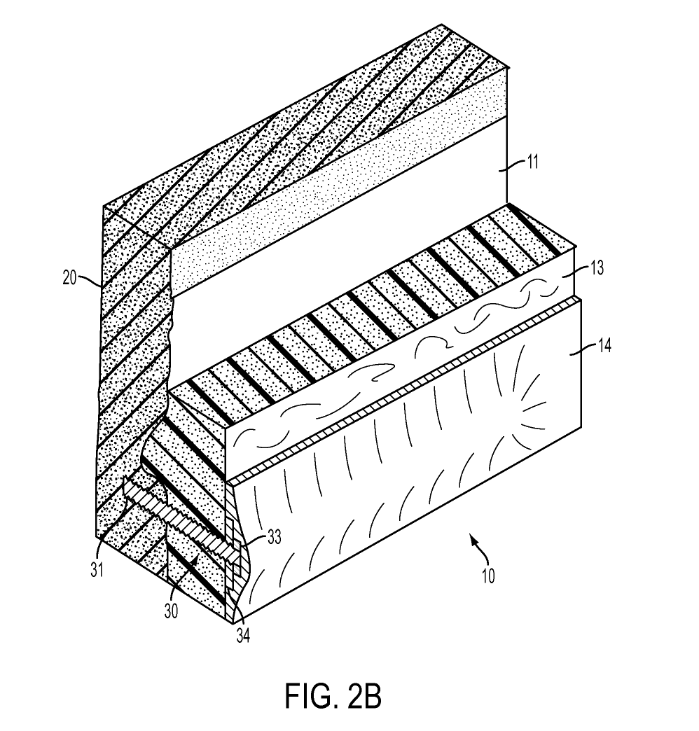

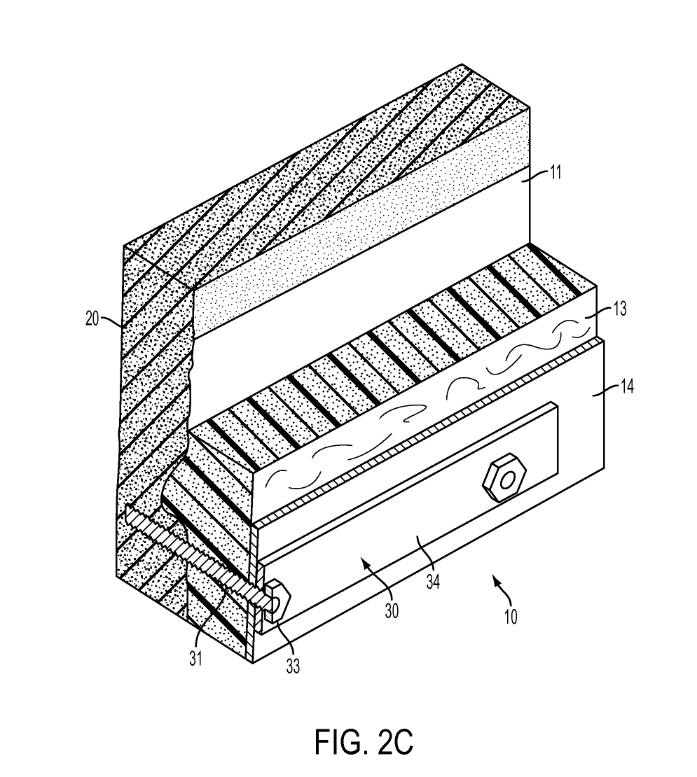

The embodiment shown in FIG. 2A is similar to that of FIG. 1A. with the exception that, the anchored multi-layer liner 10 does not include first moisture barrier layer 12, The embodiment shown in FIG. 2B is similar to that of FIG. 1B with the exception that anchored multi-layer liner 10 does not include first moisture barrier layer 12. The embodiment shown in FIG. 2C is similar to that of FIG. 1C with the exception that anchored multi-layer liner 10 does not include first moisture barrier layer 12.

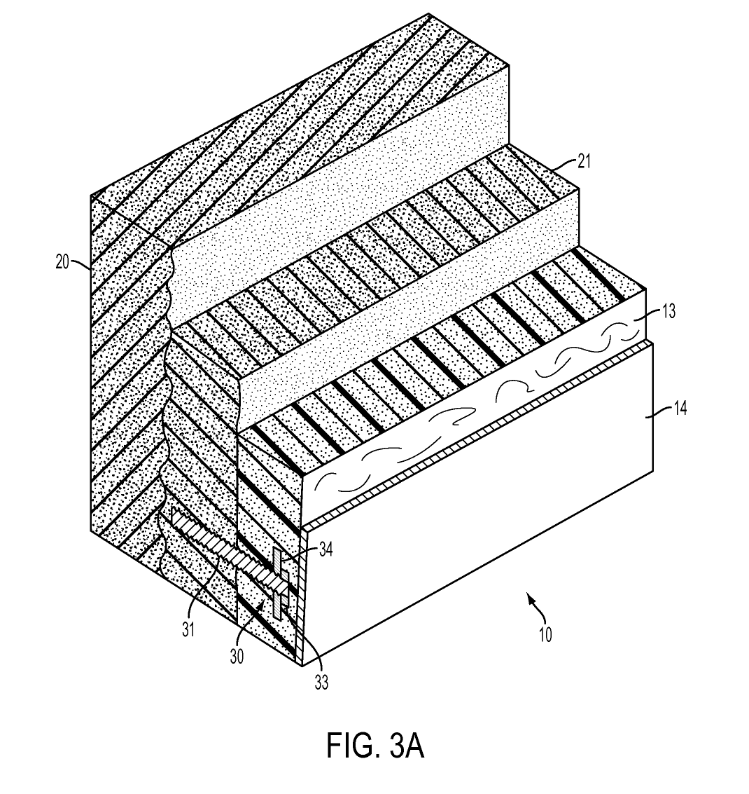

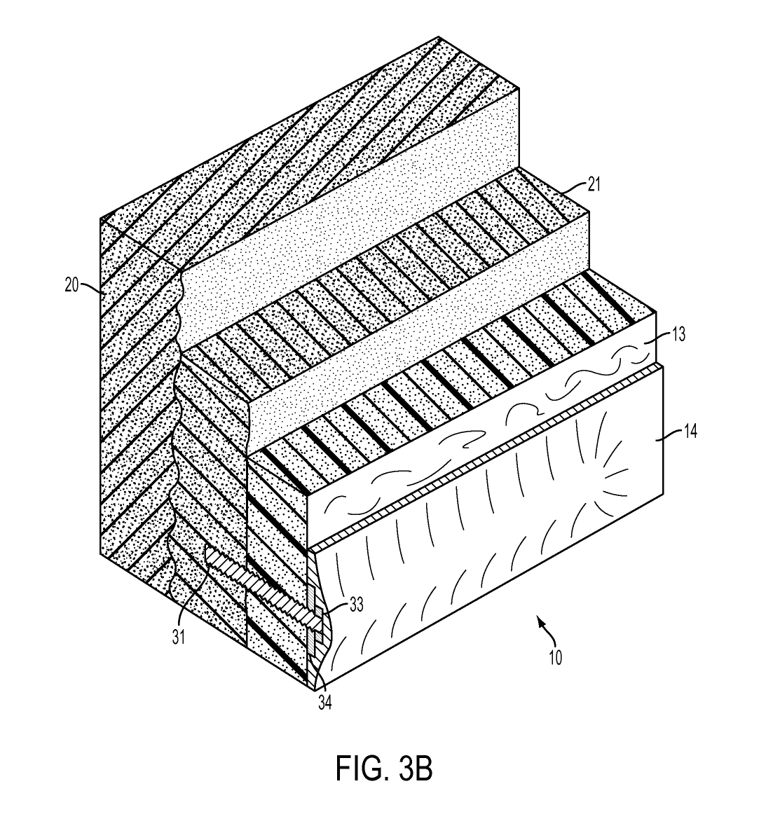

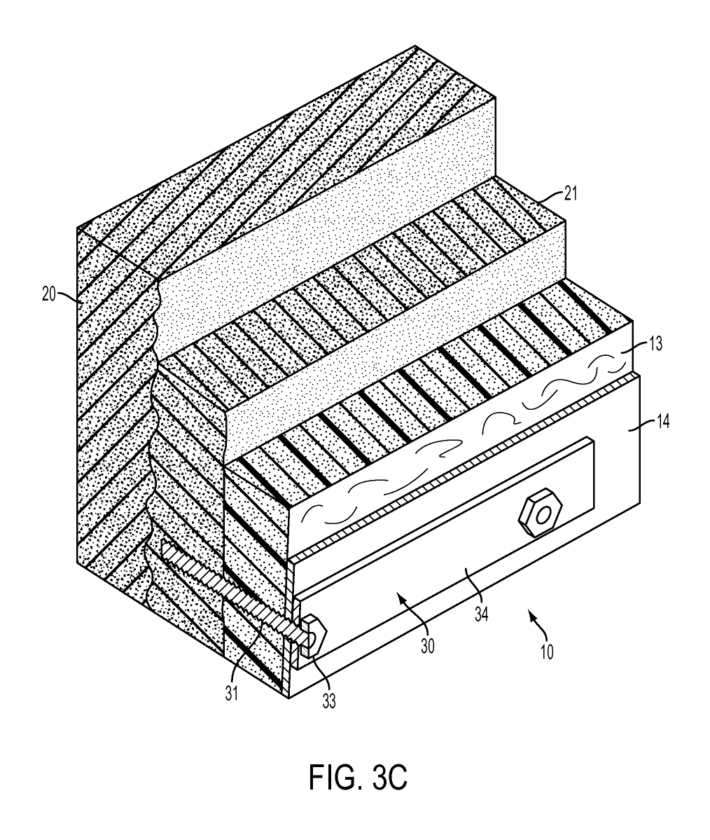

The embodiments shown in FIGS. 3A through 3C are similar to those shown in FIGS. 2A through 2C, with the exception that primer layer 11 has been replaced with a layer of cementitious material 21 that is sprayed on substrate 20 as described in U.S. Pat. No. 5,002,438 to Strong, the entire contents of which are incorporated herein by reference.

As shown in FIG. 4, in an alternate embodiment, wire mesh 36 can be used rather than anchor plates. As shown in FIG. 4, wire mesh 36 is preferably secured to the substrate after first moisture barrier layer 12 is applied so that wire mesh 36 is embedded in foam layer 13 when it is applied. Note. various types of wire mesh, of varying gauges, such as galvanized hardware cloth, can he used in the anchor system.

As shown in FIG. 5, reinforcing bar 38, commonly known as rebar, may also be used in alternate embodiments of the anchor system. As shown, the fasteners used to secure rebar 38 to the substrate 20 include a pair of ears 37 that are connected by a metal band which forms a loop 39 around the rebar 38. The ears 37 are then secured to substrate 20 by a shaft 35 passing therethrough. Preferably, rebar 38 is secured to the substrate 20 after the first moisture barrier 12 is applied and prior to the application of foam layer 13 and second barrier layer 14. In yet another embodiment, fiberglass netting, matting strips, etc., (not shown) may be secured to the substrate 20 and serve to anchor the multi-layer liner 10 thereto.

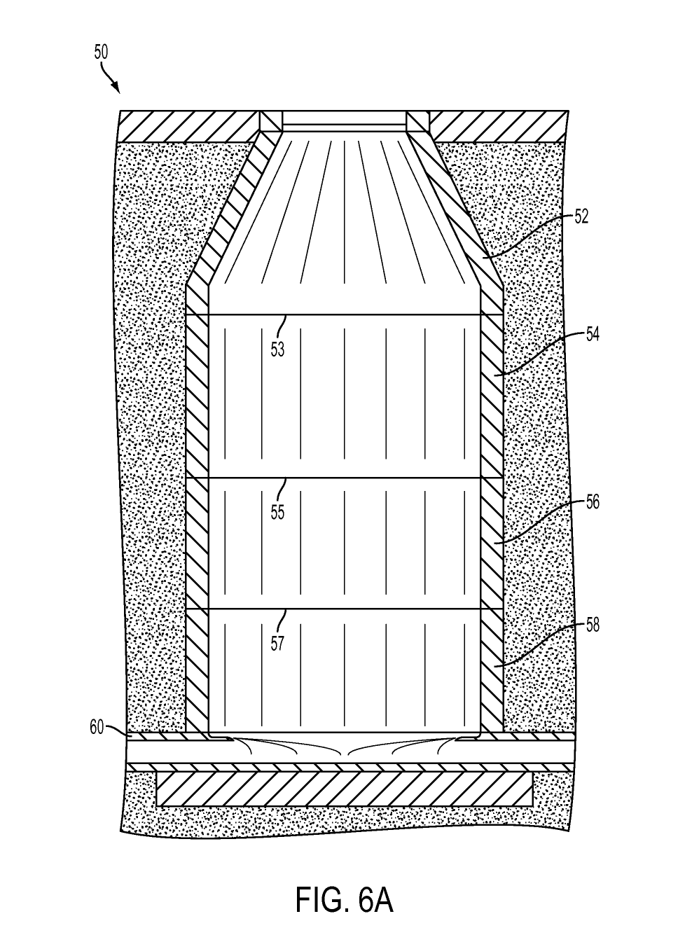

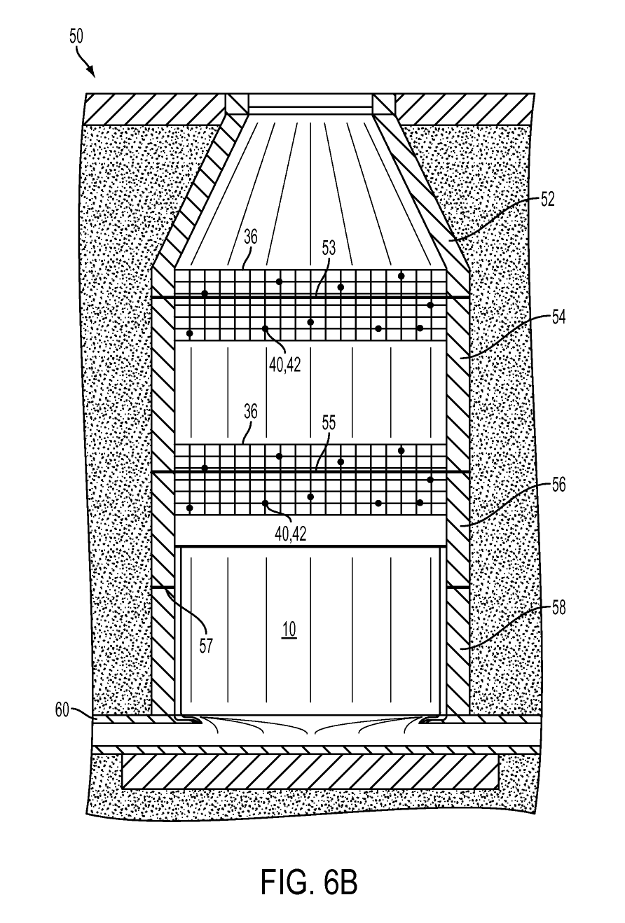

Referring now to FIGS. 6A and 6B, an example use of an embodiment of the present anchored multi-layer liner system 10 is discussed. Specifically, the wire mesh 36 embodiment shown in FIG. 4 is utilized in a pre-cast waste water component, specifically a manhole 50. As shown in FIG. 6A, the manhole 50 is constructed of a plurality of pre-cast concrete sections 52, 54. 56 and 58 that extend down to a sewer pipe 60, A first section 52 and a second section 54 meet at a first joint 53, the second section 54 and a third section 56 meet at a second joint 55, and the third section 56 and a fourth section 58 meet at a third joint 57, Note, however, more or fewer sections may be used. As previously discussed with regard to waste water components constructed of pre-cast sections, they are often susceptible to water intrusion, etc., at the joints between the various sections. Therefore, with prior art liner systems, the liners are often susceptible to separation from the substrate 20 at the joints due to hydrostatic pressure.

Referring now to FIG. 6B, to help prevent such separation, the anchor system 30 according to the present disclosure can be applied at the joints 53, 55 and 57 after water intrusion, etc., is detected or during original construction, As shown, the wire mesh 36 anchor system 30 is secured to the inner surface of the manhole 50 at each of the joints 53, 55 and 57. Alternatively, the wire mesh 36 can be secured to substantially the entire inner surface of the manhole 50 where necessary, i.e., where excessive leakage may be expected, As previously discussed, wire mesh 36 is preferably applied after a primer layer 11 and a first moisture barrier layer 12 (FIG. 4), but prior to the foam layer 13 and the second moisture barrier layer 14 (FIG. 1A). FIG. 6B shows only a partial application of the multi-layer liner 10 so that the anchor system 30 is more readily seen.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed is:

1. A multi-layer liner system for application to a substrate, comprising:
a primer layer;
a first moisture barrier layer, the first moisture barrier layer being impervious to moisture;
a second moisture barrier layer;
a foam layer, the foam layer being sandwiched between the first barrier layer and the second barrier layer; and
an anchor assembly extending outwardly from the substrate into the multi-layer liner.

2. The multi-layer liner system of claim 1, wherein the anchor assembly further comprises a fastener having a first portion embedded in the substrate and a second portion extending outwardly into the multi-layer liner.

3. The multi-layer liner system of claim 2, wherein the anchor assembly further comprises an anchor member that is secured to the second portion of the fastener.

4. The multi-layer liner system of claim 3, wherein the anchor member is an elongated anchor plate.

5. The multi-layer liner system of claim 3, wherein the anchor member is an elongated piece of reinforcing bar.

6. The multi-layer liner system of claim 3, wherein the anchor member is a wire mesh.

7. The multi-layer liner system of claim 3, wherein the anchor member is a fiberglass mesh.

8. The multi-layer liner system of claim 3, wherein the anchor member is disposed between the foam layer and the second moisture barrier layer.

9. The multi-layer liner system of claim 3, wherein the anchor member is embedded in the foam layer.

10. The multi-layer liner system of claim 3, where said first moisture barrier layer and the second moisture barrier layer are composed of a polyurea and isocyanate blend.

11. The multi-layer liner system of claim 10, where said foam layer is composed of a polyurethane.

12. The multi-layer liner system of claim 11, where the primer layer is composed of an epoxy.

13. A method of applying a multi-layer liner system to a substrate, comprising the steps of:
applying a primer layer;
applying a first moisture barrier layer to the primer layer, the first moisture barrier layer being impervious to moisture;
applying a foam layer to the first moisture barrier layer;
applying a second moisture barrier layer to the foam layer so that the foam layer is sandwiched between the first moisture barrier layer and the second moisture barrier layer; and
attaching an anchor assembly to the substrate so that the anchor assembly extends outwardly from the substrate into the multi-layer liner.

14. The method of claim 13, further comprising the step of applying a second moisture barrier layer to the foam layer so that the foam layer is sandwiched between the first moisture barrier layer and the second moisture barrier layer.

15. The method of claim 13, wherein the attaching an anchor assembly step further comprises embedding a fastener in the substrate so that a first portion of the fastener is embedded in the substrate and a second portion of the fastener extends outwardly into the multi-layer liner.

16. The method of claim 15, wherein the attaching an anchor assembly step further comprises securing an anchor member to the second portion of the fastener.

17. The method of claim 16, wherein the anchor member is disposed on the outer surface of the foam layer.

18. The method of claim 16, wherein the anchor member is embedded in the foam layer.

19. A multi-layer liner system for application to a substrate, comprising:
a foam layer, the foam layer being applied to the substrate;
a first moisture barrier layer, the first moisture barrier layer being impervious to moisture and disposed on an outer surface of the foam layer; and
an anchor assembly including a first portion disposed within the substrate and a second portion extending outwardly from the substrate into the foam layer so that the second portion is embedded in the foam layer.

20. The multi-layer liner system of claim 19, further comprising a second moisture barrier layer that is disposed between the substrate and the foam layer.
